(19) United States
(12) Patent Application Publication
(10) Pub. No.: US 2022/0340023 A1
(43) Pub. Date: Oct. 27, 2022

(54) VEHICLE CHARGING CONTROL METHOD AND DEVICE

(71) Applicant: Ceres Intellectual Property Company Limited, Horsham West Sussex (GB)

(72) Inventor: Jinli Pei, Weifang, Shandong (CN)

(21) Appl. No.: 17/764,118

(22) PCT Filed: Sep. 30, 2020
(86) PCT No.: PCT/IB2020/059154

§ 371 Date: Mar. 25, 2022

(30) Foreign Application Priority Data
Sep. 30, 2019 (CN) 201910938485.1

(51) Int. Cl. B60L 53/00; B60L 58/30; B60L 58/40; B60L 1/00

(52) U.S. Cl. CPC B60L 53/00; B60L 58/30; B60L 58/40; B60L 1/00; B60L 2200/18; B60L 2260/22

(57) ABSTRACT

A vehicle control method and device. The vehicle control method comprises the steps of generating a first control instruction and a second control instruction when a vehicle is in a parking state, so that a fuel cell control unit (FCU) is controlled to perform charging control on a battery management system (BMS) through the first control instruction, a vehicle control unit (VCU) is controlled to perform power-off control on a target component through the second control instruction, and the target component is a non-essential operation component when the vehicle is charged in a parking state; and generating a third control instruction when the vehicle is in a normal operating state, so that the VCU controls the BMS according to the third control instruction. According to the method, under different vehicle states of the BMS, the control instructions are sourced from different control units; after the vehicle enters the parking charging mode, the non-essential components are enabled to stop working to lower a parasitic load, thereby improving the charging efficiency of the system.

### TECHNICAL FIELD

The present invention relates to the technical field of vehicle control, particularly to a vehicle charging control method and device.

### BACKGROUND ART

Parking charging is one of important functions of an extended-range bus. However, the vehicle has many non-essential power-consuming components that still need to work when the bus is charged in a parking mode, such that the battery management system (BMS) has a rather low charging efficiency.

### SUMMARY OF THE INVENTION

This invention provides a vehicle charging control method and device, which improve a charging efficiency of a vehicle such as a bus charged in a parking mode.

A first aspect of the invention provides a vehicle charging control method, wherein the method comprises:
generating a first control instruction and a second control instruction when a vehicle is in a parking state, so that a fuel cell control unit (FCU) is controlled to perform charging control on a battery management system (BMS) through the first control instruction, a vehicle control unit (VCU) is controlled to perform power-off control on a target component through the second control instruction, and the target component is a non-essential operation component when the vehicle is charged in a parking state; and
generating a third control instruction when the vehicle is in a normal operating state, so that the VCU controls the BMS according to the third control instruction.

The parking state can refer to the condition where a speed of the vehicle is zero and a driver of the vehicle shifts a vehicle key from On to Off; the normal operating state can refer to the condition where the driver of the vehicle shifts the vehicle key from Off to Acc, and then from Acc to On.

The second control instruction can further comprise a delay control instruction, wherein the VCU powers down after a preset time period according to the delay instruction.

The target component can comprise a gear control unit, a transmission control unit, an all-in-one control unit, and a motor control unit.

The method can further comprise acquiring state information of the BMS; and sending the state information to the FCU, so that the FCU controls a charging current of the fuel cell according to the state information.

A second aspect of the invention provides a vehicle charging control device, wherein the device comprises:
a first response unit, used for generating a first control instruction and a second control instruction when a vehicle is in a parking state, so that an FCU unit is controlled to perform charging control on a BMS through the first control instruction, a VCU is controlled to perform power-off control on a target component through the second control instruction, and the target component is a non-essential operation component when the vehicle is charged in a parking state; and
a second response unit, used for generating a third control instruction when the vehicle is in a normal operating state, so that the VCU controls the BMS according to the third control instruction.

The parking state can refer to the condition where a speed of the vehicle is zero and a driver of the vehicle shifts a vehicle key from On to Off; the normal operating state can refer to the condition where the driver of the vehicle shifts the vehicle key from Off to Acc, and then from Acc to On.

The second control instruction can further comprise a delay control instruction, wherein the VCU powers down after a preset time period according to the delay instruction.

The target component can comprise a gear control unit, a transmission control unit, an all-in-one control unit, and a motor control unit.

The device can further comprise an acquisition unit, used for acquiring state information of the BMS; and an information sending unit, used for sending the state information to the FCU, so that the FCU controls a charging current of the fuel cell according to the state information.

Compared with the prior art, the present invention provides a vehicle control method and device. The vehicle control method comprises the steps of generating a first control instruction and a second control instruction when a vehicle is in a parking state, so that the FCU is controlled to perform charging control on the BMS through the first control instruction, the VCU is controlled to perform power-off control on the target component through the second control instruction, and the target component is the non-essential operation component when the vehicle is charged in the parking state; and generating the third control instruction when the vehicle is in a normal operating state, so that the VCU controls the BMS according to the third control instruction. According to the method, under different vehicle states of the BMS, the control instructions are sourced from different control units; after the vehicle enters the parking charging mode, the non-essential components are enabled to stop working to lower a parasitic load, thereby improving the charging efficiency of the system.

### BRIEF DESCRIPTION OF THE DRAWINGS

The drawings used in the description of the embodiments will be briefly described below. The drawings are just some embodiments of the present invention.

FIG. 1 is a flow chart of a vehicle charging control method.

FIG. 2 is a schematic view of a parasitic load when a vehicle operates and parks.

FIG. 3 is a structural schematic view of a vehicle charging control device.

### DETAILED DESCRIPTION

Embodiments of the present invention will be described below in conjunction with the drawings. The described embodiments are only some, not all of the embodiments of the present invention.

The terms “first”, “second”, etc. in the description, claims and drawings of the present invention are intended to differentiate different objects and not to describe a specific sequence.

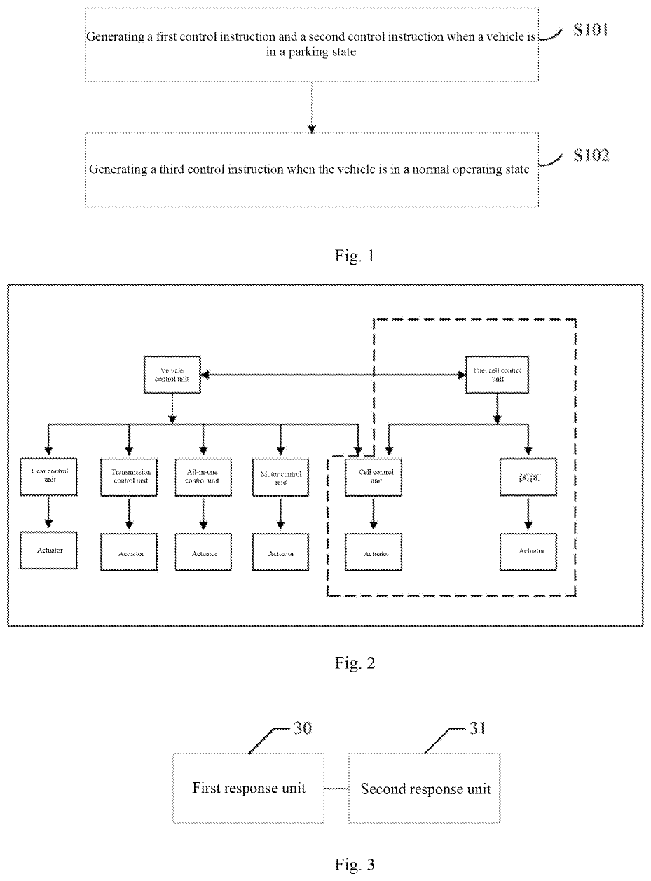

An embodiment of the present invention provides a vehicle charging control method, wherein the method can be applied to an electronic control unit of the vehicle. Referring to FIG. 1, the method comprises:

S101. generating a first control instruction and a second control instruction when a vehicle is in a parking state

S102. generating a third control instruction when the vehicle is in a normal operating state.

According to this embodiment, the control instructions of the BMS are from different control units when the vehicle is in the different states. Hence, an FCU is controlled to perform charging control on a BMS through the first control instruction, a VCU is controlled to perform power-off control on a target component through the second control instruction, and the target component is a non-essential operation component when the vehicle is charged in a parking state; also, the VCU controls the BMS according to the third control instruction.

When the vehicle operates normally, the BMS is controlled by the VCU. In the parking state, the BMS is controlled by a fuel cell control unit (FCU), so that the VCU and other non-essential operating components can be powered off to stop working, thereby lowering the drain of the vehicle parasitic load in the parking state.

When the vehicle is in the parking state, that is to say, the speed is zero, and a driver shifts the key to Off, the vehicle is considered to enter a parking charging mode. The FCU works all the time in the normal operating mode or the parking charging mode. The VCU stops working after entering the parking charging mode. After the driver shifts the key to the Acc, the VCU restarts working. Due to the fact that the BMS can be controlled by the FCU, the VCU, or the target component, the non-essential operating components, can be powered off to stop working, thereby lowering the amount of the vehicle parasitic load in the parking state. It should be noted that the non-essential operating components only have a working state (when the vehicle operates) and a stopping state (in the parking charging mode).

FIG. 2, is a schematic view of a parasitic load when a vehicle operates and parks in an embodiment of the present invention. The components in a solid box are those required when the vehicle operates, and the components in a dashed box are those required in the parking charging mode.

For the parasitic load at a vehicle level as shown in FIG. 2, the VCU delays for 10 s to power off after entering the parking mode, during which these non-essential operating components are controlled to power off, and then the FCU controls the relay to cut off 24V power for these non-essential operating components. After entering the vehicle operating mode, the FCU controls the relay to be closed to power 24V power to the non-essential operating components, and then the VCU sends a start instruction to these components to operate the vehicle.

An embodiment of the present invention further comprises:
acquiring state information of the BMS;
sending the state information to the FCU, so that the FCU controls a charging current of the fuel cell according to the state information; and
acquiring the state information of the BMS, so that the FCU can perform more accurate control.

The following paragraphs illustrate a method of switching between a vehicle operating state and a parking charging state. When the vehicle is in a parking state and the key is in Off, the VCU is delayed to power off for 10 s, and then enters the parking charging state. The BMS is shifted to be controlled by the FCU from the VCU. The FCU cuts off the 24V power of the vehicle and starts to control the BMS, and the FCU controls a charging current according to the BMS state. When the key is in the Acc, the FCU turns off the 24V power of the vehicle; when the key is shifted to On, the VCU starts working, and the BMS is shifted to be controlled by the VCU from the FCU, so that the vehicle operates.

With the help of increasing control logic, the BMS is controlled by different control units in different vehicle states. Through this method, the parasitic load in the parking state is lowered by 1 kW, i.e. 80%, thereby improving the charging efficiency of the vehicle.

An embodiment of the present invention further provides a vehicle charging control device. Referring to FIG. 3, the device comprises:
a first response unit 30, used for generating a first control instruction and a second control instruction when a vehicle is in a parking state, so that an FCU unit is controlled to perform charging control on a BMS through the first control instruction, a VCU is controlled to perform power-off control on a target component through the second control instruction, and the target component is a non-essential operation component when the vehicle is charged in a parking state; and
a second response unit 31, used for generating a third control instruction when the vehicle is in a normal operating state, so that the VCU controls the BMS according to the third control instruction.

The parking state refers to the condition where the speed of the vehicle is zero and the vehicle is in Off; the normal operating state refers to the condition where the vehicle is in the Acc.

The second control instruction further comprises a delay control instruction, wherein the VCU powers down after a preset time period according to the delay instruction.

The target component comprises a gear control unit, a transmission control unit, an all-in-one control unit, and a motor control unit.

The device can further comprise:
an acquisition unit, used for acquiring state information of the BMS; and
an information sending unit, used for sending the state information to the FCU, so that the FCU controls a charging current of the fuel cell according to the state information.

The present invention provides a vehicle control device, comprising: generating a first control instruction and a second control instruction by a first response unit when a vehicle is in a parking state, so that an FCU is controlled to perform charging control on a BMS through the first control instruction, a VCU is controlled to perform power-off control on a target component through the second control instruction, and the target component is a non-essential operation component when the vehicle is charged in a parking state; generating a third control instruction by a second response unit when the vehicle is in a normal operating state, so that the VCU controls the BMS according to the third control instruction. According to the method, under different vehicle states of the BMS, the control instructions are sourced from different control units; after the vehicle enters the parking charging mode, the non-essential components are enabled to stop working to lower a parasitic load, thereby improving the charging efficiency of the system.

The embodiments in the description are described in a progressive manner and the same or similar components among the embodiments can be mutually referred to, and each embodiment focuses on the differences from other embodiments. Because the device disclosed in the embodiments is corresponding to the method disclosed in the embodiments, the description is given briefly, and for relevant components, reference may be made to the description of the method.

Various modifications to these embodiments will be understood. The general principle defined herein can be implemented in other embodiments without departing from the scope of the present invention.

1. A vehicle charging control method, comprising:
generating a first control instruction and a second control instruction when a vehicle is in a parking state, so that a fuel cell control unit (FCU) is controlled to perform charging control on a battery management system (BMS) through the first control instruction, a vehicle control unit (VCU) is controlled to perform power-off control on a target component through the second control instruction, and the target component is a non-essential operation component when the vehicle is charged in a parking state; and
generating a third control instruction when the vehicle is in a normal operating state, so that the VCU controls the BMS according to the third control instruction.

2. The method according to claim 1, wherein
the parking state refers to the condition where the speed of the vehicle is zero and a driver of the vehicle shifts a vehicle key from On to Off; and
the normal operating state refers to the condition where the driver of the vehicle shifts the vehicle key from Off to Acc, and then from Acc to On.

3. The method according to claim 1, wherein the second control instruction further comprises a delay control instruction, wherein the VCU powers down after a preset time period according to the delay instruction.

4. The method according to claim 1, wherein the target component comprises a gear control unit, a transmission control unit, an all-in-one control unit, and a motor control unit.

5. The method according to claim 1, further comprising:
acquiring state information of the BMS; and
sending the state information to the FCU, so that the FCU controls a charging current of the fuel cell according to the state information.

6. A vehicle charging control device, comprising:
a first response unit, configured to generate a first control instruction and a second control instruction when a vehicle is in a parking state, so that an FCU is controlled to perform charging control on a BMS through the first control instruction, a VCU is controlled to perform power-off control on a target component through the second control instruction, and the target component is a non-essential operation component when the vehicle is charged in a parking state; and
a second response unit, configured to generate a third control instruction when the vehicle is in a normal operating state, so that the VCU controls the BMS according to the third control instruction.

7. The device according to claim 6, wherein the parking state refers to the condition where a speed of the vehicle is zero and a driver of the vehicle shifts a vehicle key from On to Off; the normal operating state refers to the condition where the driver of the vehicle shifts the vehicle key from Off to Acc, and then from Acc to On.

8. The device according to claim 6, wherein the first response unit is configured to generate the second control instruction that further comprises a delay control instruction, wherein the VCU powers down after a preset time period according to the delay instruction.

9. The device according to claim 6, wherein the target component comprises a gear control unit, a transmission control unit, an all-in-one control unit, and a motor control unit.

10. The device according to claim 6, wherein the device further comprises:
an acquisition unit, configured to acquire state information of the BMS; and
an information sending unit, configured to send the state information to the fuel cell control unit, so that the FCU controls a charging current of the fuel cell according to the state information.
